(19) United States
(12) Patent Application Publication
(10) Pub. No.: US 2021/0320401 A1
(43) Pub. Date: Oct. 14, 2021

(54) 5G-BASED WIRELESS SENSOR

(71) Applicant: Shenzhen Intelligent Manufacturing Velley Industrial Internet Innovation Center Co., Ltd., Shenzhen (CN)

(72) Inventors: Hai-Rong Ye, Shenzhen (CN); Xue-Qin Zhang, Shenzhen (CN); Li Ma, Shenzhen (CN); Wen-Wu Xu, Shenzhen (CN)

(21) Appl. No.: 17/025,370

(22) Filed: Sep. 18, 2020

(30) Foreign Application Priority Data
Apr. 14, 2020 (CN) 202010291408.4

(51) Int. Cl. H01Q 1/32; H04W 4/38

(52) U.S. Cl. CPC H01Q 1/3233; H04W 4/38

(57) ABSTRACT

A 5G-based wireless sensor includes at least one data acquisition unit, a signal transmission unit, an antenna coupled to the signal transmission unit, and a processor. The at least one data acquisition unit comprises a signal output port. The processor connects to the signal output port of the at least one data acquisition unit, the signal transmission unit, and the antenna. The at least one data acquisition unit collects data and processes data into a structured form to acquire a structured data. The processor constructs a table for data according to the structured data, and adds the table of data to the structured data. The signal transmission unit converts the structured data in a 5G signal, and the antenna transmits the 5G signal.

### CROSS-REFERENCE TO RELATED APPLICATIONS

This application claims priority to Chinese Patent Application No. 202010291408.4 filed on Apr. 14, 2020, the contents of which are incorporated by reference herein.

### FIELD

The subject matter herein generally relates to wireless communications, especially to a 5G-based wireless sensor.

### BACKGROUND

In prior technology, wireless sensors transmit data using ZIGBEE, or LORA. However, these wireless sensors can only achieve static data collection and the data is transmitted at low rates and low power. The amount of data transmitted by such wireless sensors does not meet high-speed, synchronous, real-time, large-scale data collection, and the needs of a future bridge, geological disasters, AGV cars, mobile networking, high-speed processing machines, and agricultural production machinery are not met.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a running environment of a 5G-based wireless sensor.

FIG. 2 is a block diagram of an embodiment of a 5G-based wireless sensor.

FIG. 3 is a block diagram of an embodiment of a data acquisition unit of the sensor of FIG. 2.

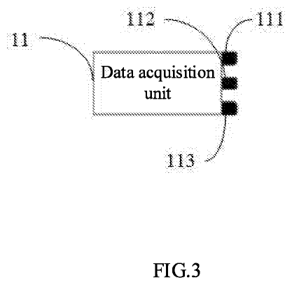

FIG. 4 is a block diagram of data in Table form.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or another storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

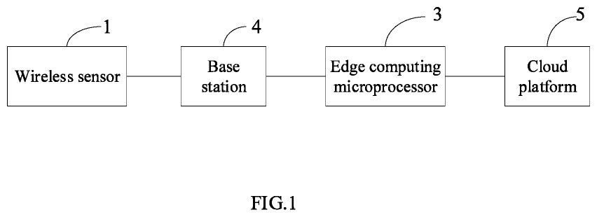

FIG. 1 illustrates a running environment of a 5G-based wireless sensor (wireless sensor 1). The wireless sensor 1 communicates with an edge computing microprocessor 3. The wireless sensor 1 collects data and sends the data to the edge computing microprocessor 3. In one embodiment, a base station 4 emits 5G signal to cover an area around the base station 4, the wireless sensor 1 communicates with the edge computing microprocessor 3 by the 5G signal sent by the base station 4. The edge computing microprocessor 3 processes the data sent by the wireless sensor 1 and sends the processed data to a cloud platform 5. In one embodiment, the base station 4 is a 5G base station, and the cloud platform 5 is a cloud platform server. In one embodiment, the edge computing microprocessor 3 communicates with the cloud platform 5 by a network (not shown in figures). In one embodiment, the network may be an internal network or the Internet. In one embodiment, the wireless sensor 1 includes, but is not limited to, a pressure and force-sensitive sensor, a humidity sensor, a magnetic sensor, a sensor of gas, a thermal (temperature) sensor, a position sensor, a liquid level sensor, an energy consumption sensor, a speed sensor, an acceleration sensor, a sensor of radiation, a vibration sensor, a vacuum sensor, a biosensor, a voice sensor, an ultrasonic sensor, an image sensor, and the like. In one embodiment, the wireless sensor can operate on an analog or a digital basis. In one embodiment, an analog sensor is used to measure a non-electrical signal and convert the measured non-electrical signal to an analog electrical signal. In one embodiment, the advantages of the analog sensor are that they are simple, easy to use, cheap, have good environmental adaptability. The main disadvantage of the analog sensor is having a low data acquisition accuracy. In one embodiment, the digital sensor has a high data acquisition accuracy, the disadvantage of the digital sensor is having low adaptability in a bad environment.

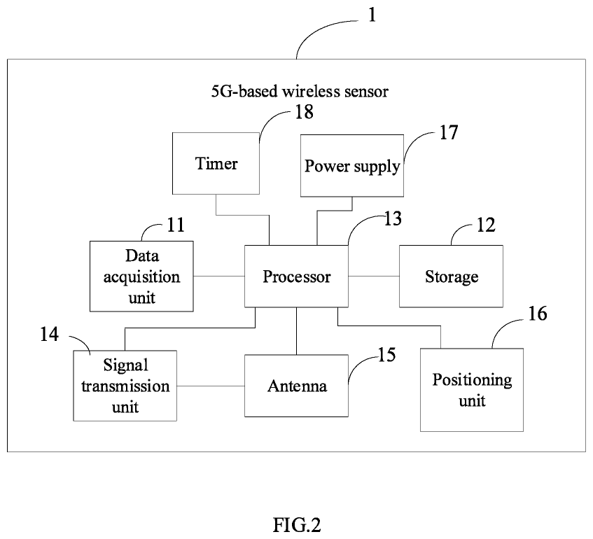

FIG. 2 illustrates the wireless sensor 1, a 5G-based wireless sensor. The wireless sensor 1 includes at least one data acquisition unit 11, a storage 12, a processor 13, a signal transmission unit 14, an antenna 15, a positioning unit 16, a power supply 17, and a timer 18. In one embodiment, the data acquisition unit 11, the storage 12, the processor 13, the signal transmission unit 14, the antenna 15, the positioning unit 16, the power supply 17, and the timer 18 are installed on a circuit board of wireless sensor 1. The processor 13 is connected to the data acquisition unit 11, the storage 12, the signal transmission unit 14, the antenna 15, the positioning unit 16, the power supply 17, and the timer 18.

In one embodiment, the data acquisition unit 11 is used to collect data. For example, the data acquisition unit 11 can collect data as to pressure, humidity, magnetism, a temperature, position, liquid level, energy consumption, velocity, acceleration, radiation, vibration, degree of vacuum, biometrics, voice, ultrasonics, images, and the presence of gas.

In one embodiment, the data acquisition unit 11 includes a power supply port 111, a ground port 112, and a signal output port 113. The power supply port 111 connects to the power supply 17 or to an external power supply. The ground port 112 connects to a common ground. The signal output port 113 connects to the processor 13. The signal output port 113 transmits the collected data to the processor 13.

In one embodiment, the wireless sensor 1 can be a single-channel sensor or a multi-channel sensor according to a number of the data acquisition units 11, each data acquisition unit 11 corresponding to a collection channel. When there is only one data acquisition unit 11, the wireless sensor 1 is a single-channel sensor, when the number of the data acquisition unit 11 is more than two, the wireless sensor 1 is a multi-channel sensor. In one embodiment, the data acquisition unit 11 processes the data by applying a structure, to acquire structured data. In one embodiment, the structured data includes a describing information and a collecting information. In one embodiment, when the wireless sensor 1 is the single-channel sensor, the description information includes an identification number of the wireless sensor 1, a name of the wireless sensor 1, and a data unit of data collected by the wireless sensor 1. In one embodiment, the collecting information includes a position information of the wireless sensor 1, a collection time information of the data, and a value of the data. In one embodiment, since the description information in the structured data includes the identification number of the wireless sensor 1, the name of the wireless sensor 1, and the data unit of data collected by the wireless sensor 1, the description information of the structured data clearly indicates the source of the data collected.

In one embodiment, when the wireless sensor 1 is the multi-channel sensor, the description information includes an identification number of the wireless sensor 1, a quantity of collection channels of the wireless sensor 1, identification numbers of each of the collection channels, and each data unit of data collected by each collection channel. In one embodiment, the collecting information includes a position information of the wireless sensor 1, each collection time information of the data collected by the collection channels, and each value of the data collected by the collection channels. In one embodiment, the data acquisition unit 11 acquires the position information of the wireless sensor 1 by the positioning unit 16. In one embodiment, the positioning unit 16 can be a GPS device. In another embodiment, the data acquisition unit 11 acquires the position information of the wireless sensor 1 by a GPS device or by a 5G signal precision positioning method. In other embodiments, the data acquisition unit 11 acquires the position information of the wireless sensor 1 by the base station 4 and the GPS device.

In one embodiment, the data acquisition unit 11 counts the passage of time when the data acquisition unit 11 is collecting the data, to get a timing by the timer 18 of the wireless sensor 1. Such timing can be regarded as the collection time information of the collecting information. In another embodiment, the data acquisition unit 11 counts time when the data acquisition unit 11 collects the data to get the timing by the timer 18 of the wireless sensor 1, and counts to obtain a count value by a counter in the wireless sensor, and regards the timing counted and the count value as the collection time information of the collecting information.

In one embodiment, the storage 12 stores data and software code of the wireless sensor 1. In one embodiment, the storage 12 can include various types of non-transitory computer-readable storage mediums. For example, the storage 12 can be an internal storage system of the wireless sensor 1, such as a flash memory, a random access memory (RAM) for the temporary storage of information, and/or a read-only memory (ROM) for permanent storage of information. In another embodiment, the storage 12 can also be an external storage system, such as a hard disk, a storage card, or a data storage medium. In one embodiment, the processor 13 processes the data collected by the data acquisition unit 11. In one embodiment, the processor 13 can be a central processing unit, or a common processor, a digital signal processor, a dedicated integrated circuit, ready-made programmable gate array or other programmable logic devices, discrete door or transistor logic devices, discrete hardware components, and so on. In another embodiment, the processor can be any conventional processor. The processor can also be a control center of the wireless sensor 1, using various interfaces and lines to connect the various parts of the wireless sensor 1.

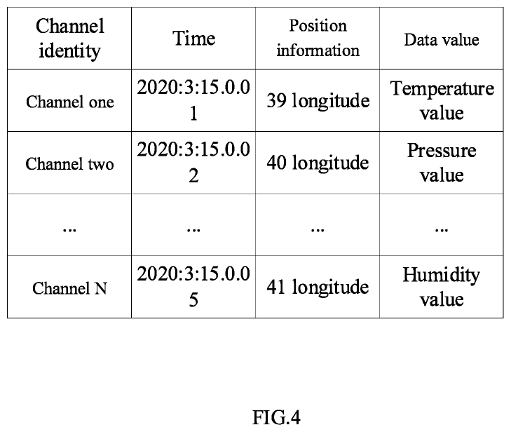

In one embodiment, the processor 13 constructs a Table of data (referring to FIG. 4—table data) according to the structured data and adds the table data to the structured data. In one embodiment, the processor 13 constructs the position information of the wireless sensor 1 and the data values of the data collected by the data acquisition unit 11 into a two-dimensional table, and adds the two-dimensional table to the structured data. In one embodiment, the processor 13 constructs the collection time information of the data and the data values of the data collected into a two-dimensional table and adds the two-dimensional table to the structured data. In one embodiment, the processor 13 constructs the position information of the wireless sensor 1, the collection time information of the data, and the data values collected by the data acquisition unit 11 into a three-dimensional table and adds the three-dimensional table to the structured data. In one embodiment, when the wireless sensor 1 is a multi-channel sensor, the processor 13 constructs a four-dimensional table containing identification number of each collection channel, the position information of the wireless sensor 1, collection time of each type of data collected by the collection channels, and values of each type of data, and adds the four-dimensional table to the structured data. In one embodiment, an (N+3)-dimensional table in the structured data of the wireless sensor 1 with N collection channels includes collection time information of the data collected by the collection channels, the position information of the data collected by the collection channels, values of each type of data collected by the collection channels, identification numbers of collection channel one, of collection channel two, and up to the identification number of collection channel N, N being an integer.

In one embodiment, the processor 13 also receives a setting instruction, and sets a working data-acquisition mode of the wireless sensor 1 as synchronous or asynchronous acquisition mode. In one embodiment, the synchronous acquisition mode of the wireless sensor 1 is that the processor 13 controls each data acquisition unit 11 to collect data at the same time, and the asynchronous acquisition mode of the wireless sensor 1 is that the processor 13 controls each data acquisition unit 11 to collect data at different times. In one embodiment, by a simultaneous collection of the data by the data acquisition modules 11, data as to multiple physical conditions can be collected in the same time period and in the same position in space. For example, collecting visual image data, temperature data, humidity data, and biological data of a farm for example simultaneously by the data acquisition units 11 of the wireless sensor 1 will reduce investment of time and human resources in data collection in scientific research, technology research and development, and greatly improves the efficiency of data collection.

In one embodiment, the processor 13 cleans the data collected by the data acquisition unit 11. In one embodiment, the processor 13 removes redundancy, fragmented data, and noise from the data according to a preset cleaning rule algorithm. In one embodiment, the preset cleaning rule algorithm can be the removal of missing values method, a mean filling method, or a hot card filling method. In one embodiment, the removal of missing values method is to directly drop samples with missing values from the data. The mean filling method is to divide the data into groups according to a property correlation coefficient of the missing value in the data, calculate a mean value of each group, and insert the mean as the missing value. The hot card filling method is to find an object in a database that has a value similar to the missing value, and then fill the value of such an object into the missing value.

In one embodiment, the signal transmission unit 14 converts the structured data in a 5G signal. In one embodiment, the antenna 15 connects to the signal transmission unit 14. The antenna 15 transmits the 5G signal. For example, the antenna 15 transmits the 5G signal to the edge computing microprocessor 3. In one embodiment, the signal transmission unit 14 is a 5G signal transmission module, and the antenna 15 is a 5G antenna. The power supply 17 provides electricity for the data acquisition unit 11, the storage 12, the processor 13, the signal transmission unit 14, the antenna 15, the positioning unit 16, and the timer 18. In one embodiment, the power supply 17 can be a switching power supply, a lithium battery, a solar cell, or a temperature-varying battery. It should be noted that the instant wireless sensor 1 is not limited to being used in 5G communication systems, but can also be used in NB-iot, Wifi6, 4G, 3G, and future 6G and other wireless communication systems.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A 5G-based wireless sensor, comprising:
at least one data acquisition unit comprising a signal output port;
a signal transmission unit;
an antenna coupled to the signal transmission unit;
a processor coupled to the signal output port of the at least one data acquisition unit, the signal transmission unit, and the antenna, the at least one data acquisition unit collecting data and performing a structured processing of the data to acquire structured data, the processor constructing a table data according to the structured data, and adding the table data to the structured data, the signal transmission unit converting the structed data in a 5G signal, and the antenna transmitting the 5G signal.

2. The 5G-based wireless sensor according to claim 1, wherein the 5G-wireless sensor is a single-channel sensor or a multi-channel sensor according to a number of the at least one data acquisition unit, wherein each of the at least one data acquisition unit corresponds to a collection channel, when the number of the at least one data acquisition module is one, the 5G-based wireless sensor is a single-channel sensor, and when the number of the data acquisition unit is more than two, the 5G-based wireless sensor is a multi-channel sensor.

3. The 5G-based wireless sensor according to claim 2, wherein the structured data comprises describing information and collecting information, the description information of the single-channel sensor comprises an identification number of the 5G-based wireless sensor, a name of the 5G-based wireless sensor, and a data unit of data collected by the 5G-based wireless sensor, the collecting information of the single-channel sensor comprises position information of the 5G-based wireless sensor, collection time information of the data, and a value of the data.

4. The 5G-based wireless sensor according to claim 2, wherein the structured data comprises description information and collecting information, the description information of the multi-channel sensor comprises an identification number of the 5G-based wireless sensor, a quantity of collection channels of the 5G-based wireless sensor, identification numbers of each of the collection channels, and each data unit of data collected by each the collection channel, the collecting information of the multi-channel comprises position information of the 5G-based wireless sensor, each collection time information of the data collected by the collection channels, and each value of the data collected by the collection channels.

5. The 5G-based wireless sensor according to claim 2, wherein the 5G-based wireless sensor further comprises a positioning unit, the at least one data acquisition unit acquires the position information of the 5G-based wireless sensor by the positioning unit.

6. The 5G-based wireless sensor according to claim 2, wherein the 5G-based wireless sensor further comprises a timer, the at least one data acquisition unit counts passage of times when the at least one data acquisition unit collects the data to get a timing by the timer, and determines the timing as the collection time information.

7. The 5G-based wireless sensor according to claim 2, wherein the 5G-based wireless sensor further comprises a timer, the data acquisition unit counts time when the data acquisition unit collects the data to get the timing by the timer, and counts to obtain a count value by a counter in the 5G-based wireless sensor, and regards the timing and the count value as the collection time information.

8. The 5G-based wireless sensor according to claim 3, wherein the processor constructs the position information of the 5G-based wireless sensor and the value of the data collected by the data acquisition unit into a two-dimensional table, and adds the two-dimensional table to the structured data.

9. The 5G-based wireless sensor according to claim 3, wherein the processor constructs the collection time information of the data and the value of the data collected by the data acquisition unit into a two-dimensional table, and adds the two-dimensional table to the structured data.

10. The 5G-based wireless sensor according to claim 3, wherein the processor constructs the position information of the 5G-based wireless sensor, the collection time information of the data, and the value of the data collected by the data acquisition unit into a three-dimensional table, and adds the three-dimensional table to the structured data.

11. The 5G-based wireless sensor according to claim 4, wherein the processor constructs identification number of each collection channel, the position information of the 5G-based wireless sensor, each collection time information of the data collected by the collection channels, and each value of the data collected by the collection channels into a four-dimensional table, and adds the four-dimensional table to the structured data.

12. The 5G-based wireless sensor according to claim 1, wherein the processor further receives a setting instruction, and set a working data-acquisition mode of the 5G-based wireless sensor as a synchronous acquisition mode or an asynchronous acquisition mode, wherein the synchronous acquisition mode of the 5G-based wireless sensor is that the processor controls each data acquisition unit to collect data at the same time, and the asynchronous acquisition mode of the 5G-based wireless sensor is that the processor controls each data acquisition unit to collect data at different times.

13. The 5G-based wireless sensor according to claim 1, wherein the processor further cleans the data collected by the at least one data acquisition unit.

14. The 5G-based wireless sensor according to claim 13, wherein the processor removes redundancy, fragmented data, and noise from the data according to a preset cleaning rule algorithm, wherein the preset cleaning rule algorithm is a removing missing value method, a mean filling method, or a hot card filling method.
